(19) United States
(12) Patent Application Publication
(10) Pub. No.: US 2010/0155561 A1
(43) Pub. Date: Jun. 24, 2010

(54) Tool Moving Module for a Positioning Platform

(76) Inventors: Chi-Pin CHOU, Taichung Industrial Park (TW); Ming-Hung Hsieh, Taichung Industrial Park (TW)

Correspondence Address: Dr. BANGER SHIA;Patent Office of Bang Shia, 102 Lindencrest Ct., Sugar Land, TX, 77479-5201, US

(21) Appl. No.: 12/340,732

(22) Filed: Dec. 21, 2008

(51) Int. Cl. F16M 11/20

(52) U.S. Cl. 248/346.01

(57) ABSTRACT

A tool moving module for a positioning platform comprises: a base on which is disposed a support table, and on the top of the support table is a pivoting portion; a support frame having a pivoting portion to be pivotally connected with the pivoting portion of the base to enable the support frame to be pivoted about the base to change its tilt angle, on a top of the support frame being formed a carrying surface around a periphery of which being arranged plural clamping members; at least one tilted control assembly disposed between the base and the support frame and located at the same side. After being fixed on the support frame, the positioning platform can be adjusted to a tilted position to substantially reduce its horizontal width, thus facilitating the transportation work.

### BACKGROUND OF THE INVENTION

1. Field of the Invention

The present invention relates to a tool moving module for moving various types of positioning platforms, and more particularly to an improved design which is aimed at facilitating the transportation of the large-scale positioning platform by reducing the horizontal width of the positioning platform.

2. Description of the Prior Art

Positioning platforms are widely used in various machining and processing activities in industrial or electronic field, and these positioning platforms are always very heavy and bulky and cannot be manually moved. Further, even if mechanical transportation means is used, it is still difficult to move the bulky positioning platform a long distance through urban roads because the roads are limited in width, especially, different countries have different restrictions on the road width, an overly wide is unable to move on a general road. When in a factory, the movement of the positioning platform can be carried out by a gantry crane. However, if there is no such a gantry crane at the worksite where is the positioning platform is assembled and used, the movement of the positioning platform will become a big problem. And the present method is to disassemble the positioning platform into units for facilitating transportation work and then the disassembled units will be reassembled into a positioning platform again after being moved to the destination, so it is troublesome and time-consuming.

The present invention has arisen to mitigate and/or obviate the afore-described disadvantages.

### SUMMARY OF THE INVENTION

The current problem in transportation of the conventional positioning platform is that it has to disassemble the positioning platform into units for facilitating transportation work and then the disassembled units will be reassembled into a positioning platform again after being moved to the destination, so it is troublesome and time-consuming.

The characteristics of the present invention are as follows:

The present invention provides a tool moving module for a positioning platform which comprises: a base on which being disposed a support table, and on a top of the support table being provided a pivoting portion; a support frame having a pivoting portion to be pivotally connected with the pivoting portion of the base to enable the support frame to be pivoted about the base to change its tilt angle, on a top of the support frame being formed a carrying surface around a periphery of which being arranged plural clamping members; at least one tilted control assembly disposed between the base and the support frame and located at the same side, the tilted control assembly being extractable and extendable and having two ends pivotally connected to the base and the support frame, respectively. The tilted control assembly, through its extending and extraction motion, makes the support frame change its tilt angle.

The functions and advantages of the present invention over the prior art:

The primary object of the present invention is to provide a tool moving module for a positioning platform, wherein, on the base is arranged the support frame which is adjustable between tilted positions and a horizontal position, so that after the positioning platform is fixed on the support frame, it can be adjusted to a tilted position by using a tilted control assembly, thus substantially reducing the horizontal width of the positioning platform, enabling the positioning platform to be transported directly on the road without requiring additional disassembly and reassembly work.

The secondary object of the present invention is to provide a tool moving module for a positioning platform, wherein the arrangement of the wheels on the base makes it possible for the tool moving module to be moved a short distance while carrying the platform directly.

Yet another object of the present invention is to provide a tool moving module for a positioning platform, when the tool moving module arrives at a destination and is positioned in place, the lift control assemblies can extend out to push the tool moving module upward, and stand on the ground as a substitution of the wheels to support the tool moving module and prevent it from sliding.

### BRIEF DESCRIPTION OF THE DRAWINGS

FIG. 1 is a perspective view of a tool moving module for a positioning platform in accordance with the present invention;

FIG. 2 is a side view showing a horizontal state of the tool moving module for the positioning platform in accordance with the present invention;

FIG. 3 is a side view showing a tilted state of the tool moving module for a positioning platform in accordance with the present invention; and

FIG. 4 shows that the tool moving module for a positioning platform in accordance with the present invention is positioned in place after arriving at a destination.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

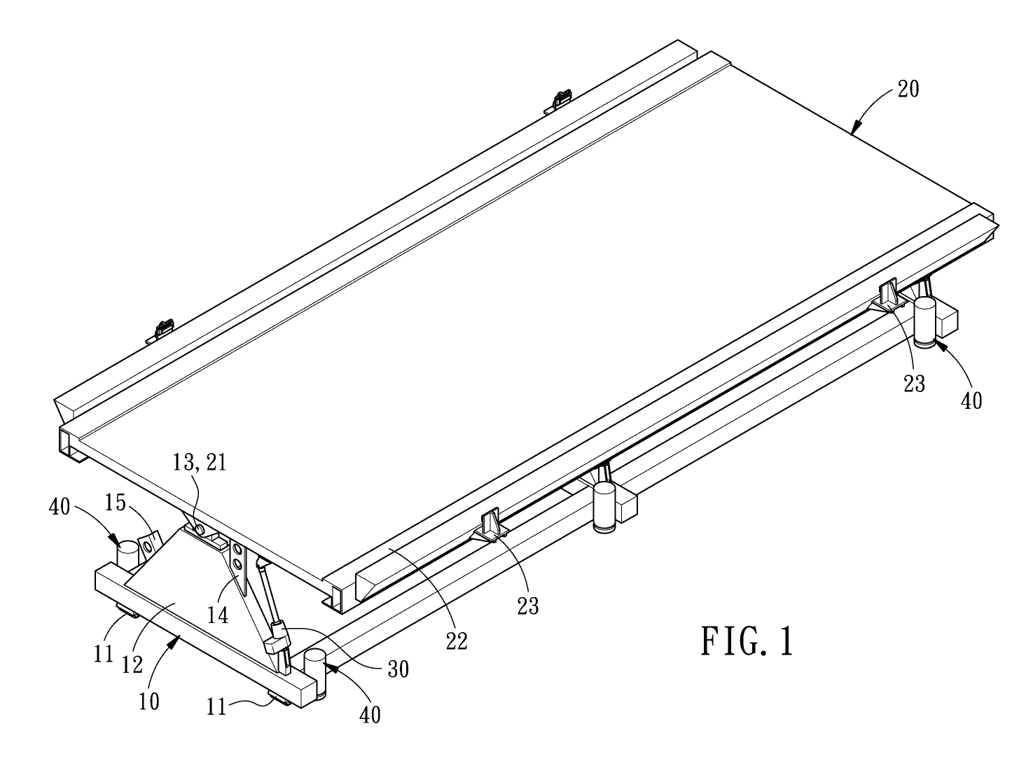

Referring to FIGS. 1-3, a tool moving module for a positioning platform in accordance with the present invention comprises: a base 10, a support frame 20, at least one tilted control assembly 30, and a plurality of lift control assemblies 40.

At the bottom of the base 10 are evenly arranged plural wheels 11, and on the top of the base 10 is a support table 12 which is preferably triangle-shaped. On the top of the support table 12 is disposed a pivoting portion 13, and at two lateral sides of the support table 12 are disposed a horizontal support portion 14 and a tilted support portion 15, respectively.

The support frame 20 has a pivoting portion 21 to be pivotally connected with the pivoting portion 13 of the base 10 so that the support frame 20 can be pivoted about the base 10 to change its tilt angle with one side of the support frame 20 going up and the other side going down. On the top of the support frame 20 is formed a carrying surface 22 around the periphery of which are arranged plural clamping members 23. When the support frame 20 is in a horizontal position on the base 10, its one side is supported by the horizontal support portion 14, and when it is tilted, its lower side will be supported by the tilted support portion 15.

The tilted control assembly 30 is disposed between the base 10 and the support frame 20 and located at the side of the support frame 20 which is going to go up when the support frame 20 is tilted. The tilted control assembly 30 is extractable and extendable and has two ends pivotally connected to the base 10 and the support frame 20, respectively. The extending motion of the tilted control assembly 30 makes the support frame 20 change its tilt angle, and the extracting motion of the tilted control assembly 30 can pull the support frame 20 back to its horizontal position.

The lift control assemblies 40 are disposed at the lower portion of the base 10 and can be controlled to extend or extract. The lift control assemblies 40 are located above the wheels 11 when in an extracted position, and will be located below the wheels 11 when in an extended position.

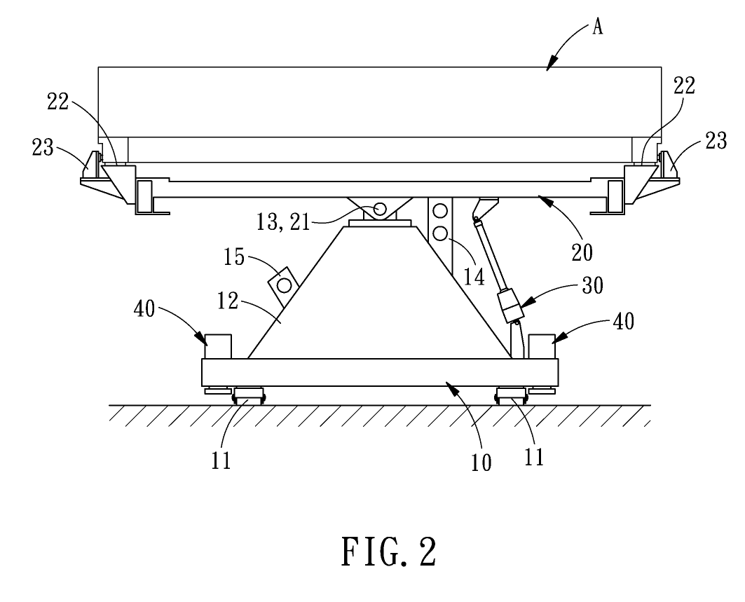

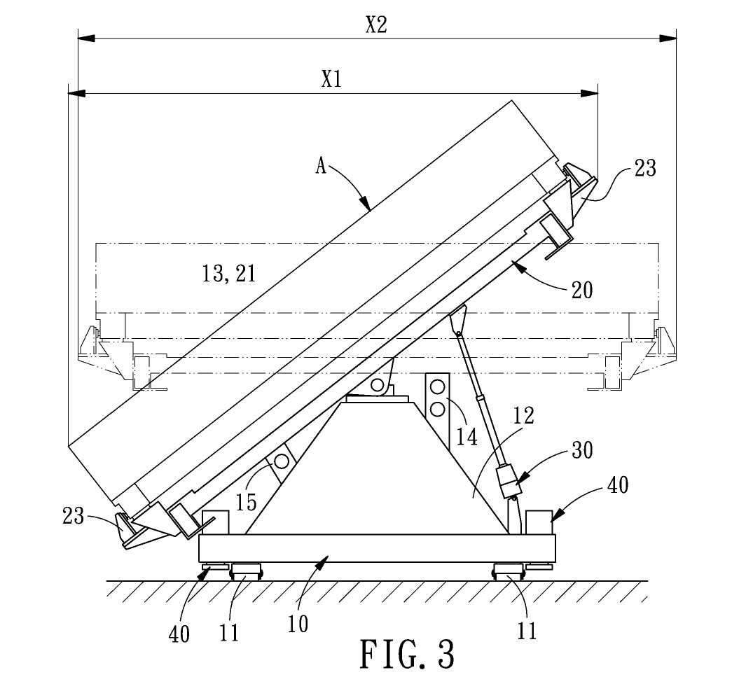

For a better understanding of the operation of controlling the tilt angle change of the tool moving module, reference should be made to FIG. 2 first. The positioning platform A is disposed on the carrying surface 22 of the support frame 20 and fixed by the clamping members 23, so that it can be prevented from unexpectedly vibrating and moving during transportation, and can also be prevented from sliding when the support frame 20 is in a titled position. After the positioning platform A is fixed, the tilted control assembly 30 extends out to make the support frame 20 pivot about the pivoting portions 13 and 21 in such a manner that one side of the support frame 20 goes up while the other side lowers down, namely, the support frame 20 is tilted at an angle with respect to the positioning platform A, as shown in FIG. 3. When the support frame 20 is tilted, its lower side is supported by the tilt support portion 15, so that, if a positioning platform A has a horizontal width (represented by X1) of 6 m when in horizontal position will be, its horizontal width which is represented by X2 will be reduced to 4.25 m after being positioned at a tilted angle of 45 degrees. The considerable reduction in horizontal width of the positioning platform A facilitates transport work, and after arriving at the destination, the tilted control assembly 30 can be extracted to pull the support frame 20 back to a horizontal position in which the previously higher side of the support frame 20 can be supported by the horizontal support portion 14.

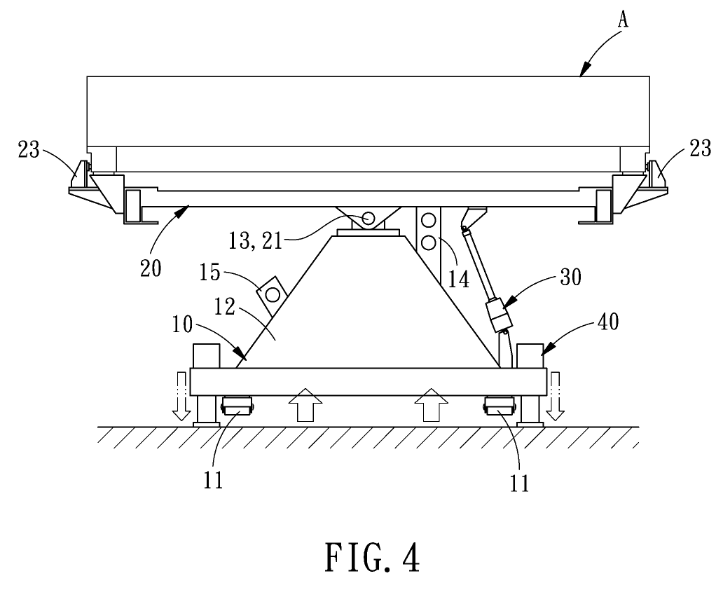

The arrangement of the wheels 11 on the base 10 makes it possible for the tool moving module to carry the platform A directly. When the tool moving module arrives at a destination and is positioned in place, the lift control assemblies 40 can extend out to push the tool moving module upward, as shown in FIG. 4, and stand on the ground as a substitution of the wheels to support the tool moving module and prevent it from sliding.

With the abovementioned arrangements, the present invention has the following advantages:

1, on the base 10 is arranged the support frame 20 which is adjustable between tilted positions and a horizontal position, so that after the positioning platform A is fixed on the support frame 20, it can be adjusted to a tilted position by using a tilted control assembly 30, thus substantially reducing the horizontal width of the positioning platform A, enabling the positioning platform A to be transported directly on the road without requiring additional disassembly and reassembly work.

2, The arrangement of the wheels 11 on the base 10 makes it possible for the tool moving module to be moved a short distance while carrying the platform A directly.

3, When the tool moving module arrives at a destination and is positioned in place, the lift control assemblies 40 can extend out to push the tool moving module upward, and stand on the ground as a substitution of the wheels to support the tool moving module and prevent it from sliding.

While we have shown and described various embodiments in accordance with the present invention, it is clear to those skilled in the art that further embodiments may be made without departing from the scope of the present invention.

What is claimed is:

1. A tool moving module for a positioning platform, comprising:
a base on which being disposed a support table, and on a top of the support table being provided a pivoting portion;
a support frame having a pivoting portion to be pivotally connected with the pivoting portion of the base to enable the support frame to be pivoted about the base to change its tilt angle, on a top of the support frame being formed a carrying surface around a periphery of which being arranged plural clamping members;
at least one tilted control assembly disposed between the base and the support frame and located at the same side, the tilted control assembly being extractable and extendable and having two ends pivotally connected to the base and the support frame, respectively, the tilted control assembly, through its extending and extraction motion, making the support frame change its tilt angle.

2. The tool moving module for a positioning platform as claimed in claim 1, wherein plural wheels are disposed at a bottom of the base.

3. The tool moving module for a positioning platform as claimed in claim 1, wherein the support table is triangle-shaped.

4. The tool moving module for a positioning platform as claimed in claim 1, wherein a horizontal support portion and a tilted support portion are disposed at two lateral sides of the support table, respectively, when the support frame on the base is in a horizontal position, it is supported by the horizontal support portion, and when it is tilted, it is supported by the tilted support portion.

5. The tool moving module for a positioning platform as claimed in claim 1, wherein the tilted control assembly is located at one side of the support frame which is going to go up when the support frame is tilted.

6. The tool moving module for a positioning platform as claimed in claim 1, wherein plural lift control assemblies are disposed at a lower portion of the base and controlled to extend or extract, the lift control assemblies are located above the wheels when in an extracted position, and will be located below the wheels when in an extended position.
